(19) United States
(12) Patent Application Publication
(10) Pub. No.: US 2007/0041718 A1
(43) Pub. Date: Feb. 22, 2007

(54) Information processing apparatus with a disc drive and a disc for such an apparatus

(75) Inventors: Wilhelmus Franciscus Johanne Fontijn, Eindhoven (NL); Wenying You, Shanghai (CN); Feng Li, Shanghai (CN); Gongming Wei, Shanghai (CN); Darwin He, Shanghai (CN); Steven Broeils Lutjns, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/571,638

(22) PCT Filed: Sep. 8, 2004
(86) PCT No.: PCT/IB04/51710

§ 371 Date: Mar. 14, 2006

(30) Foreign Application Priority Data
Sep. 16, 2003 (EP) 03103403.6

(51) Int. Cl. H04N 5/00

(52) U.S. Cl. 386/125

(57) ABSTRACT

An information processing apparatus, contains a disc (12) storing a database with a set of records, each record containing a same set of fields, each record capable of containing record specific content in the fields. A disc drive (10) reads data from the disc (12) a fragment (F) at a time. Each fragment (F) contains a plurality of data blocks that are stored substantially contiguously on the disc (12). The disc drive (10) can be switched between a read mode and a power saving mode, wherein at least part of the disc drive (10) is disabled to cut power consumption. A user interface device renders a view of the database with selected records and fields from a user selectable one of a plurality of respective subsets of the set of records and/or fields of the records. The user interface (14, 16, 18) is programmed to command the disc drive (10) to switch to the read mode to retrieve fields from records from the selected subset from the disc (12). The records are stored distributed over different fragments (F) on the disc (12), with gaps between records in the fragments, grouping said respective subsets of the records and/or fields from the records. The subsets are stored on the disc (12) positioned so that substantially each subset extends over a minimum number of contiguous fragments that is achievable for the size of the subset.

The invention relates to an information processing apparatus with a disc drive and in particular to power saving during operation of disc drives, in particular optical disc drives, when accessing information items stored on a disc. The invention also relates to a method of manufacturing such a disc in a way that power consumption by the disc drive is minimized when the information items are accessed.

Discs conventionally serve to distribute database information to users. The users are provided with an information processing apparatus with which the disc can be read, using a user interface that provides structured access to information stored on the disc. When the disc contains tourist information, for example, the apparatus may serve as an electronic tourist guide permitting a user to retrieve information about such things as museums, monuments, street maps, restaurants, hotels, railway stations or bus stops, phrases to use in various contexts etc.

In order to facilitate access to the information on the disc, a disc specific user interface is provided. The user interface enables non-expert users such as tourists to make use of stored information from such a database. For this purpose the apparatus is typically provided with an electronic display screen and an input device. The user interface instructions generally cause the display screen to display pages, with a programmed layout which show retrieved information and/or offer possibilities to enter user commands. The user interface instructions accept user input data from the input device and use this input to select information items. The user interface instructions retrieve the selected information items and display image information derived from the information items on the display screen.

In the example of the tourist guide, for example, a first page may be provided to enter a location about which the user wants more information. From this first page the user might select to switch to a second page for selecting from nearby hotels or from nearby restaurants, railway stations or bus stops. From the second page, in turn, the user might call a third page to view phrases that are useful for a particular type of environment.

The underlying data structure on the disc that enables this type of use forms a database. A database as used herein contains at least one set of records that each have predetermined fields that the user interface can use to select records and to extract information for display in a standard way. A set of records with restaurant data may be provided for example. The records in a set are of identical type, each with a predetermined set of fields, whose content may vary from record to record. A respective record may be provided for example for each restaurant, with attributes such as “city”, “street”, “kitchen type” (French, Cantonese etc.), “photograph of interior” etc. The user interface specifies which sets of records of the database and which fields in each set should be accessed.

Such a database can have considerable size. Not only can there be a considerable number of records, but individual records may be large, for example if they contain image data for displaying photographs on the display screen. The database can be a database in a strict sense, comprising standardized table data structures for different sets, but the word “database”, as used herein, is not limited to this strict sense.

For tourist applications, for example, it is desirable that this type of information processing device is portable and that the database and the user interfaces can be supplied on exchangeable optical discs. Portable equipment has to be powered from a battery. Therefore reduction of power consumption is an important design consideration for this type of equipment. In the case of equipment with a disc drive power consumption can be reduced by switching to a power saving mode in which components like the motor, the laser and the head actuators draw no current. During read operations the disc drive is switched to a read mode, in which these components receive power supply current, but between read operations the disc drive switches to the power saving mode. The shorter the time the disc drive operates in the read mode, the less energy it consumes from the battery.

The percentage of time that the disc drive has to operate in the read mode depends on the task that has to be performed, on the architecture of the equipment that accesses the disc drive to perform that task and on the arrangement of data on the disc. Answering queries over a database that is stored on the disc typically requires keeping the disc drive out of the power saving mode for a relatively high percentage of time. Especially compared with streaming applications (e.g. playing a video or audio stream) the percentage of time that the disc drive is out of the power saving mode for retrieving the same amount of data is very high for answering queries.

For data stream access, measures are known that minimize the disc seek time to load the datastream. The entire data stream is stored contiguously on disc as much as possible, in the order that the data will be used, so that a minimum of head movements is needed to read the data. Although aimed at optimising the use of the disc bandwidth, this also reduces power consumption, since it reduces the time that the disc needs to be powered is minimized inherently.

Similarly, storing the records of a database contiguously could be used to minimize the time needed for loading data during database access. However, in practice this does not reduce power consumption in the case of a database application. In the case of a individual database accesses the complex, non-linear access pattern increases the time that the disc-drive needs to be fully powered. In this way information processing devices that use database-like information stored on a disc present an energy consumption problem.

Among others, it is an object of the invention to provide for lower power consumption in equipment with a disc drive, when having database-like access to information.

The invention provides for a method according to claim 1. According to the invention, the records of the database or even parts of the records are stored distributed over different locations on the disc rather than arranged contiguously. Records and/or part of the attributes are grouped adaptive to a combination of the architecture of the disc drive and the queries that are defined by the user interface instructions.

The architecture of the disc drive defines the amount of data that can be read at a time, for example due to the length of a buffer memory that is used to receive data read from disc during a read operation. Often fragments are defined for a disc, which defines the basic unit of fetching. In this case the buffer size is preferably an integer multiple (1×, 2× etc) of the fragment size. Especially in the case of optical disc drives the fragment is usually relatively large, e.g. 2 Mbyte.

To minimize power consumption the user interface structure is analyzed to identify how the database on the disc will be accessed most frequently. Subsets of records that the user interface is expected to load together most frequently are grouped and stored in one or more contiguous fragments so that the records of each subset are contained in a minimum number of contiguous fragments, preferably in a single fragment. For example, records from each subset may be stored starting from the start of a respective fragment, leaving a gap on the disc (which may be used for storing other data) before the start of another fragment, in which records from another subset are stored. In this way the subset crosses a minimum number of fragment boundaries, whereby the number of fragments used for storing the subset is minimized. Of course, without deviating from the invention, instead a gap of the same size of the gap at the end, or a plurality of gaps with the same aggregate size, may be located anywhere among the records of a subset, not just at the end of the subset. Also fragments that store different subsets need not be stored contiguously. On the other hand more than one subset may be stored in one fragment if there is room.

In spite of the distributed storage the records from different subsets in combination functionally preferably still form an entire database that can be searched and retrieved with less frequently used queries from the user interface, or from other user interfaces. Preferably, the records themselves may even be stored distributed, so that only the fields needed by the user interface are stored in the minimum fragments, other fields being stored in other fragments, so as to minimize the number of fragments that needs to be loaded by the user interface.

The subsets, which are thus used for structuring storage of records, may be determined in various ways. For example, in one embodiment the user interface uses database queries with joined tables in which fields from different tables (sets of records) are combined if they have matching fields and satisfy some user selectable criterion. In this case, the subsets of the records that are each stored in a minimum number of fragments may be selected on the basis of field contents that occur in a further set of records that the user interface joins with the records to select the subset. Storing the possible subsets on disc in anticipation of these queries minimizes the power consumed during reading. Preferably, the further records from the further table that are required for the query are stored in the same fragment or fragments as the records from the subset, in the gap or gaps mentioned before. This also minimizes power consumption.

In another embodiment the user interface enables the user to select subsets for retrieval. In this embodiment the subset that the user interface allows to be selected by the user are used to structure storage on disc, so as to minimize the number of fragments that has to be loaded for each individual selection.

In another embodiment records that the user interface is expected to need in response to different user selections (i.e. that belong to multiple subsets) are copied to multiple fragments so that no additional fragments need to be loaded when a subset of records is loaded and a record belongs to another subset as well.

Preferably the records are stored as a file in a file structure. In this case the file is stored distributed over the fragments so that the subsets of records from the file are each stored in a respective fragment.

As has been mentioned the invention is especially advantageous for battery powered apparatuses, because it reduces power consumption from batteries. Also the invention is especially advantageous for optical discs, because optical disc drives are power efficient for a large fragment size.

These and other objects and advantages of the invention will be described in more detail using the following figures

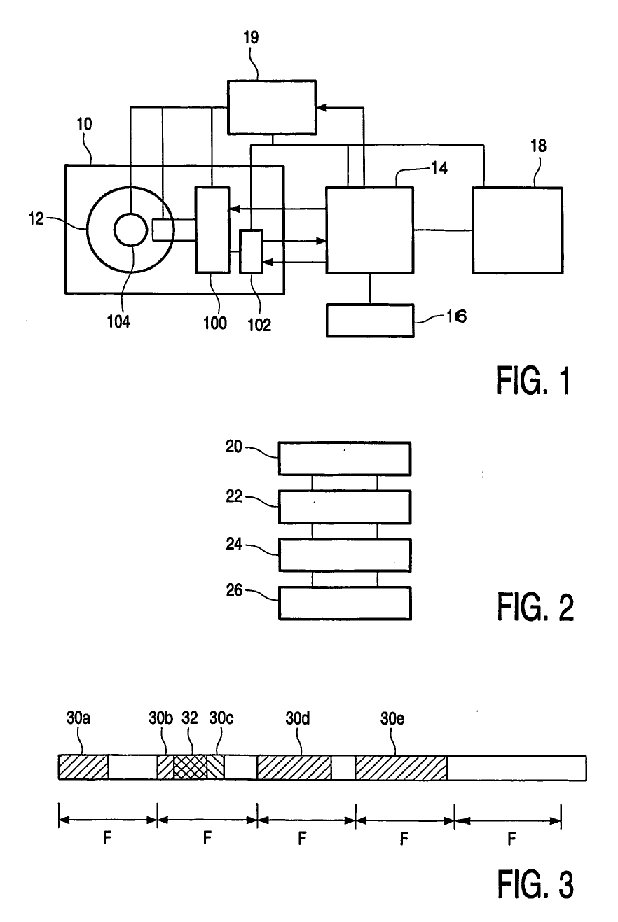

FIG. 1 shows an information processing apparatus

FIG. 2 shows an access architecture

FIG. 3 shows a disc layout

FIG. 1 shows an information processing apparatus with a disc drive 10, a processor 14, an input device 16, an output device 18 and a power supply 19. Disc drive 10 contains an optical disc 12 and has a motor 104 for spinning disc 12, a read unit 100 arranged to read data from disc 12, as well as a buffer memory 102 for storing data that has been read from disc 12 for retrieval by processor 14. Processor 14 has a control output coupled to read unit 100, a read data interface coupled to buffer memory 102, a user data input coupled to input device 16, a user data output coupled to output device 18 and a power supply mode output coupled to power supply 19. Power supply 19, which contains a battery (not shown) has a high power mode output coupled to read unit 100 including laser (not shown separately) in read unit 100 and to motor 104. Power supply 19 has an all mode output coupled to processor 14, output device 18 and if necessary to input device 16. Output device 18 is for example a display screen and input device 16 may for example be a keypad or a touch sensitive device coupled to the screen. The invention will be described using this type of device, but it should be realized that other types of input/output, such as speech input and/or output may be used as well or instead.

In operation the device is able to assume alternatively one of at least two modes, which include a read mode and a power saving mode. In the read mode the entire apparatus receives power supply current from a battery in power supply unit 19. This includes power supply current to the motor, laser and read electronics of disc drive 10. In the read mode disc 12 is spinned and data is read from disc 12. In the power saving mode the motor, laser and read electronics receive no power supply current, but processor 14, output device 18 and a buffer part of read unit 100 do receive power supply current.

Initially, when the apparatus has been switched on, the apparatus is in the power saving mode, in which buffer memory 102, processor 14 and output device 18 are supplied with power, but not motor 104, or read unit 100. In the power saving mode processor 14 is capable of executing programs and reading from buffer memory 102, but disc 12 is not directly accessible without switching to the read mode.

The invention will now be described in terms of database operation. However, it should be understood that the word “database” is used loosely to refer to a collection of records of at least one type, that defines a predetermined set of fields for each record, so that records of a same type can be searched for and used exchangeably. Table 1 shows an example of the fields of restaurant records used for a table of restaurants.

TABLE 1

| key | Name | address | kitchen | photograph |
|---|---|---|---|---|
| 1 | golden duck | x1 | beijing | <jpeg data> |
| 2 | jolly fisherman | x2 | fish | <jpeg data> |
| 3 | wild boar | x3 | venison | <jpeg data> |
| 4 | chez jean | x4 | french | <jpeg data> |
| 5 | tai palace | x5 | tai | <jpeg data> |
| . . . | . . . | . . . | . . . | . . . |

Initially processor 14 executes a basic interface program to display a user interface page on output device 18. When a user enters an access request on user input device 16, processor 14 receives this request and starts execution of a database user interface program. The user interface causes output device 18 to show an interface screen with one or more user data entry fields. The user enters data for these fields on input device 16. The program receives this data and generates a database query in response to the data The generation of a database query causes processor 14 to switch power supply 19 from the power saving mode to the read mode, supplying power supply current to the motor, the laser etc. of disc drive 10. Read unit reads one or more fragments that contain required data from disc 12 and stores each fragment in buffer memory 102. When more fragments are loaded, they are processed each before the next is stored. Afterwards power supply 19 is switched back to the power saving mode.

The records from the database may be split for example in a short part, which contains mainly fields for search purposes and a longer part which contains photographs for display. Tables 2 and 3 show examples of such shorted part of a table

TABLE 2

| key | kitchen | address |
|---|---|---|
| 1 | Beijing | x1 |
| 2 | Fish | x2 |
| 3 | Venison | x3 |
| 4 | French | x4 |
| 5 | Tai | x5 |
| . . . | . . . | . . . |

TABLE 3

| key | Name | photograph |
|---|---|---|
| 1 | golden duck | <jpeg data> |
| 2 | jolly fisherman | <jpeg data> |
| 3 | wild boar | <jpeg data> |
| 4 | chez jean | <jpeg data> |
| 5 | tai palace | <jpeg data> |
| . . . | . . . | . . . |

In this case, the short parts of all records may be stored in one fragment, whereas the long parts are distributed over multiples fragments, grouped in a manner so that the long parts of records that the user interface is expected to need together when the user interface searches with the short parts are located in the same fragment, e.g. grouped so that records about restaurants in a certain geographical region are located in the same fragment, or records about restaurants with the same type of kitchen are located in the same fragment. Preferably, the disc also contains map information that maps key values to fragments where records with the key value are stored.

When the user interface is activated it activates the disc drive to load the table with short parts and deactivates the disc drive 10. When the user enters selection data in the user interface, the user interface consults the table with the short parts to select the records selected by the selection data For example, when the information processing apparatus is used as an electronic tourist guide, the user may enter data identifying a location (city and/or street name) in a first interface page. Next the user interface activates disc drive 10 and commands disc drive 10 to load the selected records from table with the long parts. Because these records are in a single fragment disc drive 10 needs to be active only to load a single fragment. Afterwards it is switched back to the power saving mode.

The fact that the records are stored distributed in such a way that power consumption is optimized may be transparent for the user interface. Typically a layered architecture is used that makes the user interface independent of the disc architecture.

FIG. 2 shows a transparent access architecture used to access disc 12. The architecture is organized in layers. Top layer 20 is the application layer that contains a program that controls the user interface. The second layer 22 is a database layer that contains a database engine. The third layer 24 is a file system layer and the bottom layer 26 is a hardware control layer. When no strict database is used, so that the database functions are performed by the user interface itself second layer 22 may be omitted. The idea behind the layered architecture is that there are standard interfaces for exchanging commands and responses between successive pairs of layers, so that software and/or hardware can be designed to performed functions belonging to a layer independent of implementation choices made in other layers.

The application layer 20 generates query commands expressed in a standard data base language. The database layer 22 generates file access commands, naming files that contain database records needed to respond to the query. The file system layer 24 generates block retrieval commands from specified locations on disc 12 to retrieve blocks that belong to a file. The hardware control layer controls movement of the read head (not shown) and capture of data in read buffers.

The effect of the layered architecture is that the application layer 20 is independent of the location of the relevant records on disc 12. To the application layer it appears that a query command results in a list of records, independent of the implementation of other layers. The implementation merely has to ensure that it responds to the commands with sufficient speed. Thus, different versions of hardware and different discs may be used interchangeably.

The invention preferably leaves this layered architecture intact, so that any application can be used to access the database in any desired way. However, by arranging data on disc 12 according to the expected use by a given user interface, power consumption is reduced. Access to disc 12 using the layered architecture is made power efficient by grouping records on disc 12 according to the expected query when disc 12 is manufactured. This does not fit into the layered model because, information relevant to the application layer 20 (concerning the type of query that will be generated) is used to take positioning decisions about position of data on the disc, even though positioning is functionally transparent to the application layer 20 and the database layer 24 (i.e. do not affect the queries or the result). The reason that information about the application layer 20 is used to influence the lowest layers is that power consumption can be reduced in this way.

In another example, the interface program selects the records that must be accessed in different interface levels. For example, when the information processing apparatus is used as an electronic tourist guide, the user may enter data identifying a location (city and/or street name) in a first interface page. In response to such a request the user interface program generates a query to a database that is stored on disc 12. The interface program shows the result on output device 18, for example in the form of general information (including e.g. a map of an area around the location).

Subsequently, the user may select to activate a second user interface page from this first user interface page, for example a user interface page for selecting a restaurant. When the information on disc 12 has been positioned in anticipation of activation of the second user interface page, grouped into groups of records which result from different selections at the first user interface page, disc drive 10 is not required to be switched back to the read mode to retrieve the relevant data Each group is positioned on the disc in the same fragment as the data loaded in response to the request for information about the location, so that the relevant information will be scooped up into buffer memory 102 when data is read from disc 12 for the location query.

In another example, record selection involves joining multiple tables. This will be illustrated with a toy example wherein the database contains a kitchen table with records for different kitchen types.

TABLE 4

| | | | | |
|---|---|---|---|---|
| kitchen type | dish | type of meat | spicy | etc. |

| | | |
|---|---|---|
| . . . | . . . | . . . |

In the illustration, the user interface has an interface page for selecting restaurants according to the meat served, implemented by joining the restaurant table and the kitchen table, to form joined records, each with fields from the restaurant table and the kitchen table that have equal content in the “kitchen” and “kitchen type” fields respectively. For a give geographical location the user interface may collect from the joined table the different types of meat that are served and give the user the opportunity to select one type of meat. Thereupon the user interface presents records for those restaurants that have a kitchen that serves the selected type of meat.

When a disc is prepared for use with this type of interface, records in the restaurant table are grouped into groups, each with all restaurants in a region that have a kitchen that, according to the kitchen table, serves a type of meat particular to the group. Each group is stored in a respective fragment.

The example illustrates the point that grouping of records in a table, for the purpose of putting records from the table together in a fragment can be controlled by another table, when there is an interface that will query the database using joining of the tables.

As will be gathered from the examples, the invention applies to the case where a database and a user interface are defined. Before storing the database on a disc 12, one or more expected frequent query patterns due to the user interface are determined. The query patterns may be identified in any form, such as, for example, by identifying an interface page that uses one or more user dependent field values to identify records from a table that contain the values in their fields, or an interface page that combines tables so that one table defines a subset of field values that the user can select from another table etc.

The result of query pattern identification is that one can specify for each pattern groups of records from a table that the user interface will need together to satisfy a query (e.g. each group responsive to an alternative user input). When the disc is manufactured the records of each group are stored together in a fragment, or if they do not fit in one fragment, over a number of contiguous fragments, so that the number of fragments is the minimum possible number of fragments that can store the group.

Optionally, one also identifies the fields from the records that will be used in a pattern of access. In this case at least some (large) fields that are not needed in the pattern are not stored in the fragments, also in order to reduce the number of fragments that needs to be loaded to satisfy a user interface query.

Optionally, in the case that a query pattern requires records from a plurality of tables, the records from the different tables that are needed to satisfy a particular query are stored together in a fragment, or in a minimum number of fragments.

When the groups of records that are required to satisfy different frequently used queries have mutual overlap, the overlapping records are preferably copied to different fragments so that each fragment contains the complete group. Optionally, the tables may be expanded with data to disambiguate these duplicate records. As another option, one may search for different groups that have so much overlap that they can all be stored together in the same fragment or in a contiguous sequence of fragments.

Preferably, although the location of the records in disc 12 is thus rearranged, architecture for accessing the records is kept generic, so that the database stored on the disc can still be accessed completely by any application. The disc may therefore still be used for applications for which the locations have not been optimized, be it that in general this will cause more power consumption.

FIG. 3 shows a resulting disc layout, with a number of consecutive fragments F. Groups of records 30a-d that are stored in different fragments F. In one fragment F, several groups 30b,d are in the same segment. These groups 30b,d have an overlap 32 that allows the groups 20b,c to fit in one segment when stored together.

1. An information processing apparatus, comprising:
a disc (12) storing a database with a set of records, each record containing a same set of fields, each record capable of containing record specific content in the fields;
a disc drive (10) arranged to read data from the disc (12) a fragment (F) at a time, each fragment (F) containing a plurality of data blocks that are stored substantially contiguously on the disc (12), the disc drive (10) being switchable between a read mode and a power saving mode, wherein at least part of the disc drive (10) is disabled to cut power consumption;
a user interface device (14, 16, 18), programmed to render, to a user, a view of the database with selected records and fields from a user selectable one of a plurality of respective subsets of the set of records and/or fields of the records, the user interface (14, 16, 18) defining a process of selecting the subsets, the user interface (14, 16, 18) being programmed to command the disc drive (10) to switch to the read mode to retrieve fields from records from the selected subset from the disc (12);
wherein the records are stored distributed over different fragments (F) on the disc (12), with gaps between records in the fragments, grouping said respective subsets of the records and/or fields from the records, the subsets being stored on the disc (12) positioned so that substantially each subset extends over a minimum number of contiguous fragments that is achievable for the size of the subset.

2. An information processing apparatus according to claim 1, wherein substantially each of the subsets is stored in a respective one of the fragments (F).

3. An information processing apparatus according to claim 1, wherein the data base contains a further set of further records, each further record containing a same further set of fields, the user interface (14, 16, 18) being arranged to define a dynamically formed joined set with joined records that combine records and further records that have matching content in at least part of the fields and further fields, the user interface (14, 16, 18) composing the subset from joined records that satisfy a user selected criterion, so that each respective one of said subsets contains all records that are part of joined records that satisfy a respective selectable user criterion.

4. An information processing apparatus according to claim 1, wherein all further records that are part of joined records that satisfy a respective selectable user criterion are stored in the same fragment or fragments as the subset of all records that are part of joined records that satisfy a respective selectable user criterion.

5. An information processing apparatus according to claim 1, wherein the user interface (14, 16, 18) has a first and a second level, a user selection made at the first level determining the subset, from which user selection is available at the second level.

6. An information processing apparatus according to claim 1, wherein the minimum number of fragments contains less than all fields of each record in the subset, so that all fields needed in the view are contained in the minimum number of fragments.

7. An information processing apparatus according to claim 1, wherein respective ones of the user selectable subsets, which share a particular record, are stored in respective groups of said minimum number of fragments that all contain a copy of the particular record.

8. An information processing apparatus according to claim 1, wherein the disc (12) contains a file structure, including a file that contains the set of records, wherein the file is stored distributed over the fragments so that the subsets of records from the file are each stored in a respective fragment.

9. An information processing apparatus according to claim 1, wherein the apparatus is battery powered.

10. An information processing apparatus according to claim 1, wherein the disc-drive (10) is an optical disc drive.

11. A disc (12) for use in an information processing apparatus according to claim 1, the disc (12) containing a database with a set of records, each record containing a same set of fields, each field with a content particular to the record, the records being stored distributed over different fragments on the disc, with gaps between records in the fragments, grouping respective subsets of the records and/or fields from the records, respective subsets of records, from which a user interface device is programmed to select in response to different user selections, being stored on the disc positioned so that substantially each subset extends over a minimum number of contiguous fragments that is achievable for the size of the subset.

12. A disc (12) according to claim 11, storing a program of instructions that defines the user interface.

13. A disc (12) according to claim 11, wherein substantially each of the subsets is stored in a respective one of the fragments.

14. A disc (12) according to claim 11, wherein the data base contains a further set of further records, each further record containing a same further set of fields, the user interface being arranged to define a dynamically formed joined set with joined records that combine records and further records that have matching content in at least part of the fields and further fields, the user interface composing the subset from joined records that satisfy a user selected criterion, so that each respective one of said subsets contains all records that are part of joined records that satisfy a respective selectable user criterion.

15. A disc (12) according to claim 11, wherein all further records that are part of joined records that satisfy a respective selectable user criterion are stored in the same fragment or fragments as the subset of all records that are part of joined records that satisfy a respective selectable user criterion

16. A disc (12) according to claim 11, wherein the user interface has a first and a second level, a user selection made at the first level determining the subset, from which user selection is available at the second level.

17. A disc (12) according to claim 11, wherein the minimum number of fragments contains less than all fields of each record in the subset, so that all fields needed in the view are contained in the minimum number of fragments.

18. A disc (12) according to claim 11, wherein respective ones of the user selectable subsets, which share a particular record, are stored in respective groups of said minimum number of fragments that all contain a copy of the particular record.

19. A disc (12) according to claim 11, wherein the disc contains a file structure, including a file that contains the set of records, wherein the file is stored distributed over the fragments so that the subsets of records from the file are each stored in a respective fragment

20. A disc (12) according to claim 11, wherein the disc is an optically readable disc.

21. A method of manufacturing a disc (12) that stores a data base database stored comprising a set of records, each record containing a same set of fields, each record capable of containing record specific content in the fields, data on the disc being organized into predetermined fragments (F), for use in a disc drive being arranged to access the disc a fragment (F) at a time when in the read mode, the method comprising:
supplying the database;
defining a user interface for rendering to a user a view of the database with selected records and fields from a user selectable one of a plurality of respective subsets of the set of records and/or fields of the records, the user interface defining a process of selecting the subsets, the user interface being programmed to command the disc drive switch to the read mode to retrieve fields from records from the selected subset from the disc;
grouping the records according to respective user selectable subsets;
storing the records distributed over different fragments on the disc, with gaps between records in the fragments, grouping said respective subsets of the records and/or fields from the records, the subsets being stored on the disc positioned so that substantially each subset extends over a minimum number of contiguous fragments that is achievable for the size of the subset.

22. A method according to claim 21, wherein substantially each of the subsets is stored in a respective one of the fragments (F).

23. A method according to claim 21, wherein the data base contains a further set of further records, each further record containing a same further set of fields, the user interface being arranged to define a dynamically formed joined set with joined records that combine records and further records that have matching content in at least part of the fields and further fields, the user interface composing the subset from joined records that satisfy a user selected criterion, so that each respective one of said subsets contains all records that are part of joined records that satisfy a respective selectable user criterion.

24. A method according to claim 21, wherein all further records that are part of joined records that satisfy a respective selectable user criterion are stored in the same fragment or fragments as the subset of all records that are part of joined records that satisfy a respective selectable user criterion.

25. A method according to claim 21, wherein the user interface has a first and a second level, a user selection made at the first level determining the subset, from which user selection is available at the second level.

26. A method according to claim 21, wherein the minimum number of fragments contains less than all fields of each record in the subset, so that all fields needed in the view are contained in the minimum number of fragments.

27. A method according to claim 21, wherein respective ones of the user selectable subsets, which share a particular record, are stored in respective groups of said minimum number of fragments that all contain a copy of the particular record.

28. A method according to claim 21, wherein the disc contains a file structure, including a file that contains the set of records, wherein the file is stored distributed over the fragments so that the subsets of records from the file are each stored in a respective fragment.

29. An information processing apparatus according to claim 1, wherein the disc-drive is an optically readable disc.
